(19) United States
(12) Patent Application Publication
(10) Pub. No.: US 2025/0353642 A1
(43) Pub. Date: Nov. 20, 2025

(54) ZIPPER ASSEMBLY FOR A FLEXIBLE PACKAGE AND HAVING A PRESSURE SENSITIVE ADHESIVE

(71) Applicant: Illinois Tool Works Inc., Glenview, IL (US)

(72) Inventor: Eric P. Plourde, Frankfort, IL (US)

(73) Assignee: Illinois Tool Works Inc., Glenview, IL (US)

(21) Appl. No.: 19/098,427

(22) Filed: Apr. 2, 2025

Related U.S. Application Data
(60) Provisional application No. 63/647,845, filed on May 15, 2024.

(51) Int. Cl. B65D 33/25; B65D 33/16; C09J 7/38

(52) U.S. Cl. CPC B65D 33/2508; B65D 33/1691; C09J 7/38; C09J 2301/302

(57) ABSTRACT

A zipper assembly for a resealable package can include opposing webs each having an interlocking side and an opposite film side. Each of the interlocking sides can have a protruding interlocking body that mates with the protruding interlocking body of the other interlocking side to mate the webs with each other. The zipper assembly also can include PSA layers on the film sides of the webs. The PSA layers can include PSA that couples the webs to inside surfaces of films of the resealable package. The zipper assembly can include release liners disposed on the PSA layers. The release liners can be separated from the PSA layers prior to pressing the webs and the PSA layers into contact with the films of the resealable package to adhere the webs to the films.

### CROSS-REFERENCE TO RELATED APPLICATIONS

This application claims priority to U.S. Provisional Application No. 63/647,845 (filed 15-May-2024), the entire disclosure of which is incorporated herein by reference.

### BACKGROUND

### Technical Field

The subject matter described herein relates to flexible packages, such as bags, pouches, and the like, having zipper assemblies that allow the packages to be repeatedly sealed and unsealed.

### Discussion of Art

Zippers can be attached to flexible films of packages by heat sealing the zipper to the film and then forming the film into a reclosable flexible package such as a pouch or bag. The zipper can be attached to the film on a pouch machine or on a form, fill, seal (FFS) machine. The use of heat to attach the zipper has some disadvantages such as seal dwell time required to allow heat to transmit through layer(s) of packaging film and/or zipper flanges. Another disadvantage is the distortion of the packaging film resulting from the high temperatures required to heat seal the zipper to the film.

A need may exist for a zipper or zipper assembly that decreases or eliminates the shortcomings described above.

### BRIEF DESCRIPTION

A zipper assembly for a resealable package can include opposing webs each having an interlocking side and an opposite film side. Each of the interlocking sides can have a protruding interlocking body that mates with the protruding interlocking body of the other interlocking side to mate the webs with each other. The zipper assembly also can include PSA layers on the film sides of the webs. The PSA layers can include PSA that couples the webs to inside surfaces of films of the resealable package. The zipper assembly can include release liners disposed on the PSA layers. The release liners can be separated from the PSA layers prior to pressing the webs and the PSA layers into contact with the films of the resealable package to adhere the webs to the films.

A method for forming or creating a zipper assembly may include co-extruding opposing webs, interlocking bodies that protrude from the webs, PSA layers on the webs, and release liners on the PSA layers. The webs, the interlocking bodies, the PSA layers, and the release liners can be co-extruded to form a zipper assembly for a resealable package.

A zipper assembly for a resealable package can include opposing webs each having an interlocking side and an opposite film side. Each of the interlocking sides can have a protruding interlocking body that mates with the protruding interlocking body of the other interlocking side to mate the webs with each other. The zipper assembly also can include PSA layers on the film sides of the webs. The PSA layers including PSA that can couple the webs to inside surfaces of films of the resealable package.

### BRIEF DESCRIPTION OF THE DRAWINGS

The inventive subject matter may be understood from reading the following description of non-limiting embodiments, with reference to the attached drawings, wherein below:

FIG. 1 illustrates one example of a recloseable or resealable package;

FIG. 2 illustrates a cross-sectional view of one example of the zipper assembly shown in FIG. 1 prior to attaching the zipper assembly to film(s) of the package shown in FIG. 1; and

FIG. 3 schematically illustrates one example of an extrusion system.

### DETAILED DESCRIPTION

One or more examples of the inventive subject matter described herein relate to zipper assemblies that are coupled with flexible films of package assemblies using pressure sensitive adhesives (PSAs) or cohesives instead of using heat seals to couple the zipper assemblies to the films. The PSA can couple the zipper assembly to a film without heat being applied to the zipper assembly or film. For example, the zipper assembly can be affixed to the film using the PSA while the zipper assembly, the film, and the PSA is/are at room temperature (e.g., at a temperature between twenty and twenty-two degrees Celsius in one example; at a temperature between twenty and twenty-nine degrees Celsius in another example; at a temperature between twenty-four and twenty-nine degrees Celsius in another example).

A release liner may be applied to the exposed PSA prior to adhering the zipper assembly to the package film to prevent the zipper assembly from being inadvertently sealed to itself or another surface prior to adhering the zipper assembly to the package film. While the release liner could be silicone coated paper, this may require producing the release liner in a separate process, then be slit or cut to size, spooled and transported to where the liner can be unwound and applied over the PSA coated zipper assembly. This process is complicated and expensive. Instead, the release liner may be co-extruded on the PSA with the PSA and the zipper assembly. Co-extruding these three components together can significantly reduce the cost and complexity of forming the zipper assembly with the PSA and release liner.

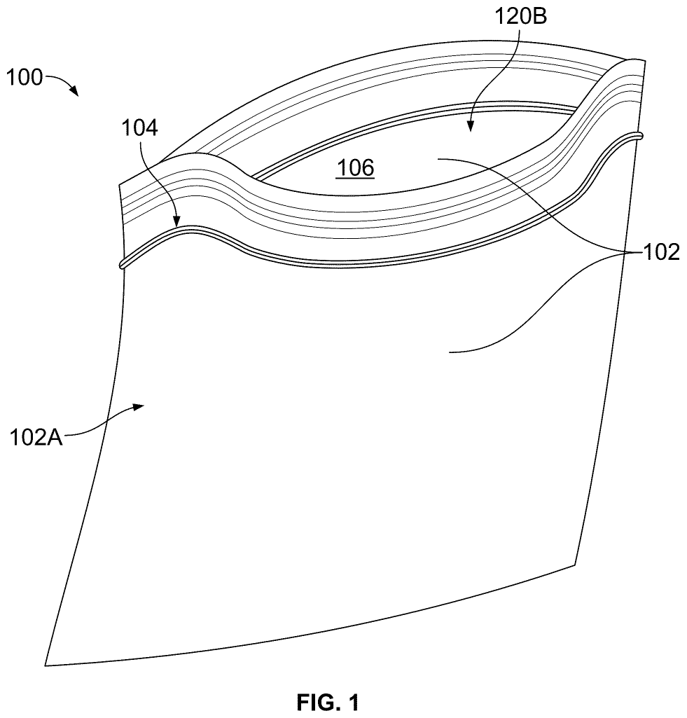

FIG. 1 illustrates one example of a recloseable or resealable package 100. The package 100 may be a flexible enclosure that includes one or more films 102 formed in the shape of an open-ended bag. A zipper assembly 104 may be coupled with the films 102 at or near an opening 106 of the enclosure 100. The zipper assembly 104 may attach to itself to allow a consumer to repeatedly open and close the enclosure 100. The films 102 may include a front film 102A and a rear film 102B, which may be parts of the same film or may be separate films that are bonded or sealed together.

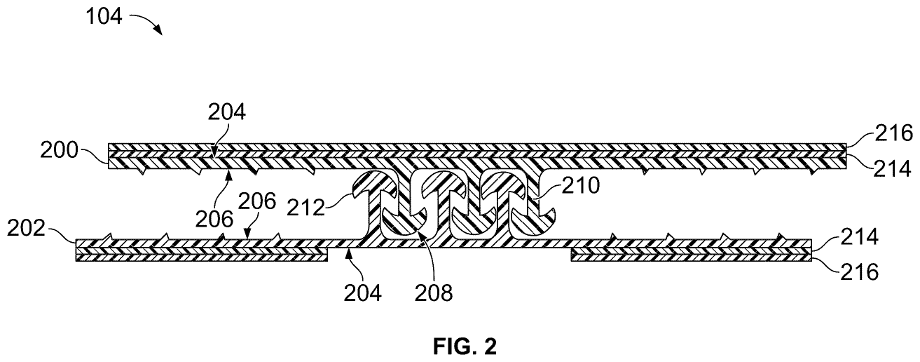

FIG. 2 illustrates a cross-sectional view of one example of the zipper assembly 104 shown in FIG. 1 prior to attaching the zipper assembly 104 to the film(s) 102. The zipper assembly 104 includes webs or flanges 200, 202. One of the webs or flanges 200 or 202 can be affixed to an inside surface of the front film 102A shown in FIG. 1 and the other web or flange 202 or 200 can be affixed to an inside surface of the rear film 102B shown in FIG. 1.

Each of the webs 200, 202 can be a planar body having a film side 204 and an opposite interlocking side 206. The film sides 204 face and are adhered to the inside surfaces of the films 102. The interlocking sides 206 face each other and away from the inside surfaces of the films 102. The interlocking sides 206 include interlocking bodies 208 protruding away from the interlocking sides 206 toward the other web 200, 202. The interlocking bodies 208 are formed as elongated stems 210 having enlarged heads 212 at distal ends of the stems 210. As shown, the webs 200, 202 can be pressed together to mate the interlocking bodies 208 with each other to seal the package 100 closed. The webs 200, 202 can be pulled apart to separate the interlocking bodies 208 from each other and open the packet 100. One or more of the interlocking bodies 208 may have another shape, such as a groove in which the head 212 is received.

The zipper assembly 104 may be referred to as a multi-piece or segment zipper assembly as are multiple (e.g., at least two) webs or flanges 200, 202 that are separate from each other but that mate with each other to close the zipper assembly 104. While the zipper assembly 104 is described as being formed from two separate webs or flanges 200, 202, the zipper assembly 104 may be formed from three or more separate webs or flanges 200, 202. Optionally, the zipper assembly 104 can be a single piece or segment zipper assembly, or a self-mating zipper assembly. For example, a continuous zipper assembly 104 may be attached to the films 102A, 102B and wrap around the interior of the films 102A, 102B to encircle the opening through which a consumer accesses the interior volume via the open zipper assembly 104. Different portions of the length of the zipper assembly 104 may be pressed against each other to mate the interlocking bodies 208 and seal the zipper assembly 104 closed.

The webs 200, 202 and interlocking bodies 208 may be formed from one or more polymers, such as polyolefins (e.g., polyethylene or polypropylene). The film sides 204 of the webs 200, 202 have layers or coatings 214 of a PSA material. The PSA layers or coatings 214 may be extrudable materials, and can be co-extruded with the webs 200, 202 and interlocking bodies 208. For example, the PSA layers or coatings 214 may be extruded from the same extrusion die as the webs 200, 202 and interlocking bodies 208 at the same time that the webs 200, 202 and interlocking bodies 208 are extruded.

The PSA layers 214 and the webs 200, 202 may be formed from compatible materials. Compatible materials may be materials having stronger chemical bonds between the materials when compared with materials that are not compatible with each other. Compatible polymers may not exhibit phase separation when blended with each other. Incompatible polymers may exhibit phase separation when blended.

Covering the exposed surfaces of the PSA layers 214 can be release liners 216. The release liners 216 can be planar bodies of materials having low bond strength with the PSA layers 214. For example, the bond strength between the webs 200, 202 and the PSA layers 214 may be much larger than the bond strength between the PSA layers 214 and the release liners 216. The bond strength between the webs 200, 202 and the PSA layers 214 may be ten times larger or more than the bond strength between the PSA layers 214 and the release liners 216. The materials forming the PSA layers 214 and the release liners 216 may be incompatible polymers.

The weaker bond strength between the PSA layers 214 and the release liners 216 allows for the release liners 216 to be peeled away from the PSA layers 214 without removing the PSA layers 214 from the webs 200, 202. The webs 200, 202 can then be pressed onto the inside surfaces of the film(s) 102 to couple the zipper assembly 104 to the film(s) 102.

The release liners 216 can be made from multiple layers of material. For example, each release liner 216 can be formed from a base layer having a lower compatibility with the PSA layer 214. This material can include or can be silicone as one example, while the PSA layer 214 can include or be formed from a solvent-acrylic PSA, an emulsion-acrylic PSA, or the like. The base layer can be co-extruded with a supporting layer. The supporting layer may be a substrate providing mechanical strength to the release liner 216. For example the supporting layer can be formed from polyolefin, polyvinyl chloride, etc. The strength of the supporting layer can be greater than the base layer so that pulling on the release liner 216 can pull the supporting layer and the base layer away from the PSA layer 214 without removing the PSA layer 214 from the webs 200, 202 and without breaking or tearing the release liner 216. The base layer may contact the PSA layer and be between the PSA layer and the supporting layer.

The webs 200, 202, interlocking bodies 208, PSA layers 214, and the release liners 216 may all be extruded out of a single extrusion die at the same time. For example, these parts may all be co-extruded together. Alternatively, only one of the webs 200, 202 may be co-extruded with the interlocking bodies 208 of that web 200 or 202, the PSA layers 214 on that web 200 or 202, and the release liners 216 of that web 200 or 202 may all be extruded out of a single extrusion die at the same time.

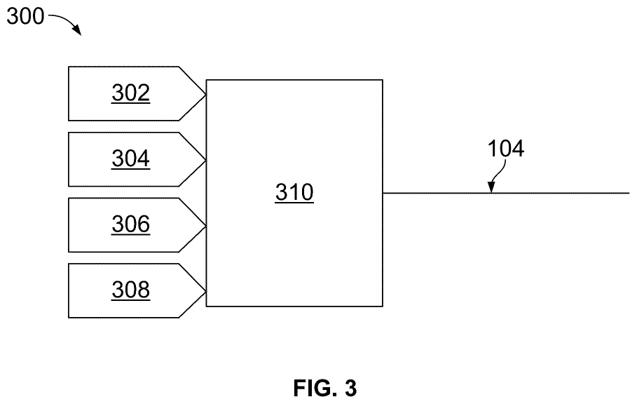

FIG. 3 schematically illustrates one example of an extrusion system 300. The extrusion system 300 may co-extrude the webs 200 and/or 202, the interlocking bodies 208, the PSA layers 214, and the release liners 216. The extrusion system 300 can include supply assemblies 302, 304, 306, 308 that each provide a different material used to fabricate the zipper assembly 104. For example, the supply assembly 302 can receive polymer pellets and include one or more heaters for changing the phase of the pellets (e.g., by melting the pellets), and can include one or more motors for driving the melted polymer into a die 310. The polymer(s) provided to the die 310 by the supply assembly 302 can include the polymer(s) used to create the web(s) 200 and/or 202 and the interlocking bodies 208.

The supply assembly 304 can receive polymer pellets, melt the pellets, and drive the melted polymer into the die 310. The polymer(s) provided to the die 310 by the supply assembly 304 can include the polymer(s) used to create the PSA layers 214. The supply assembly 306 can receive polymer pellets, melt the pellets, and drive the melted polymer into the die 310. The polymer(s) provided to the die 310 by the supply assembly 306 can include the polymer(s) used to create the base layer 218 of the PSA layer 214. The supply assembly 308 can receive polymer pellets, melt the pellets, and drive the melted polymer into the die 310. The polymer(s) provided to the die 310 by the supply assembly 308 can include the polymer(s) used to create the supporting layer 220 of the PSA layer 214.

The die 310 can include openings 312 having shapes of the different parts of the zipper assembly 104. For example, one or more of the openings 312 can be shaped to form the webs 200 and/or 202 and interlocking bodies 208, another opening 312 can be shaped to form the PSA layers 214, another opening 312 can be shaped to form the base layer 218, and another opening can be shaped to form the supporting layer 220. As the supply assemblies 302, 304, 306, 308 pump or push the melted polymer through the openings 312 in the die 310, the polymers may be extruded from the die 310 at the same time to form the zipper assembly 104. Optionally, the die 310 can include fewer openings 312 than the number of different parts of the zipper assembly 104. For example, the die 310 may have a single opening 312 shaped to form the webs 200, 202, the interlocking bodies 208, the PSA layers 214, the base layer 218, and the supporting layer 220. As the supply assemblies 302, 304, 306, 308 pump or push the melted polymer through the single opening 312 in the die 310, the polymers may be extruded from the die 310 at the same time to form the zipper assembly 104. Co-extruding the various parts of the zipper assembly 104 can reduce the complexity, time, and cost of manufacturing the zipper assembly 104 relative to separately forming two or more of the parts of the zipper assembly 104 and then combining the parts to form the zipper assembly 104.

In another example, a method for manufacturing the zipper assembly can include directing different polymers into the same die. The different polymers may exit the die through different openings that are shaped to form the different parts of the zipper assembly, as described above. In this way, the parts of the zipper assembly may be co-extruded together at the same time.

A zipper assembly for a resealable package can include opposing webs each having an interlocking side and an opposite film side. Each of the interlocking sides can have a protruding interlocking body that mates with the protruding interlocking body of the other interlocking side to mate the webs with each other. The zipper assembly also can include PSA layers on the film sides of the webs. The PSA layers can include PSA that couples the webs to inside surfaces of films of the resealable package. The zipper assembly can include release liners disposed on the PSA layers. The release liners can be separated from the PSA layers prior to pressing the webs and the PSA layers into contact with the films of the resealable package to adhere the webs to the films.

The PSA layers may affix the webs to the films of the resealable package without heating the PSA layers or the films. The PSA layers can couple the webs to the films of the resealable package at room temperature. The webs, the interlocking bodies, the PSA layers, and the release liners can be formed from materials that can be or that are co-extruded to form the webs, the interlocking bodies, the PSA layers, and the release liners at a common time. Optionally, these components may be separately formed or extruded and later combined.

The release liners can include silicone or be formed solely from silicone. The zipper assembly can be a single segment zipper assembly configured to mate to itself. For example, the zipper assembly may be continuous from one end to an opposite end with the ends at the outer ends of the length of the zipper assembly, where the zipper assembly can mate with and seal to itself when two segments of the continuous length of the zipper assembly between the opposite ends are pressed together. Optionally, the zipper assembly can be a multi-segment zipper assembly having different segments configured to mate to each other. For example, the zipper assembly may be formed from at least two (but could be more) segments, with one segment mating with another segment.

A method for forming or creating a zipper assembly may include co-extruding opposing webs, interlocking bodies that protrude from the webs, PSA layers on the webs, and release liners on the PSA layers. The webs, the interlocking bodies, the PSA layers, and the release liners can be co-extruded to form a zipper assembly for a resealable package.

The webs, the interlocking bodies, the PSA layers, and the release liners can be co-extruded with each of the webs having an interlocking side and an opposite film side, and with the interlocking bodies configured to mate with each other. The webs, the interlocking bodies, the PSA layers, and the release liners can be co-extruded with the PSA layers disposed on the film sides of the webs and the PSA layers including PSA configured to couple the webs to inside surfaces of films of the resealable package. The webs, the interlocking bodies, the PSA layers, and the release liners can be co-extruded with the release liners disposed on the PSA layers. The release liners can be separated from the PSA layers prior to pressing the webs and the PSA layers into contact with the films of the resealable package to adhere the webs to the films.

A zipper assembly for a resealable package can include opposing webs each having an interlocking side and an opposite film side. Each of the interlocking sides can have a protruding interlocking body that mates with the protruding interlocking body of the other interlocking side to mate the webs with each other. The zipper assembly also can include PSA layers on the film sides of the webs. The PSA layers including PSA that can couple the webs to inside surfaces of films of the resealable package.

The zipper assembly optionally may include release liners on the PSA layers and that can be separated from the PSA layers prior to pressing the webs and the PSA layers into contact with the films of the resealable package to adhere the webs to the films. The release liners can include silicone or be formed from silicone. The PSA layers and the release liners can be formed from incompatible polymer materials (e.g., materials that are dissimilar or that do not chemically bind to each other). The release liners can each be formed from multiple layers. Optionally, the PSA layers and the webs can be formed from compatible polymer materials (e.g., materials that are not dissimilar or that do chemically bind to each other).

The PSA layers can affix the webs to the films of the resealable package without heating the PSA layers or the films. For example, the PSA layers can couple the webs to the films of the resealable package at room temperature. The PSA layers can couple the webs to the films of the resealable package at a temperature between twenty and twenty-nine degrees Celsius.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A zipper assembly for a resealable package, the zipper assembly comprising:
opposing webs each having an interlocking side and an opposite film side, each of the interlocking sides having a protruding interlocking body configured to mate with the protruding interlocking body of the other interlocking side to mate the webs with each other;
pressure sensitive adhesive (PSA) layers disposed on the film sides of the webs, the PSA layers including PSA configured to couple the webs to inside surfaces of films of the resealable package; and
release liners disposed on the PSA layers, the release liners configured to be separated from the PSA layers prior to pressing the webs and the PSA layers into contact with the films of the resealable package to adhere the webs to the films.

2. The zipper assembly of claim 1, wherein the PSA layers are configured to affix the webs to the films of the resealable package without heating the PSA layers or the films.

3. The zipper assembly of claim 1, wherein the PSA layers are configured to couple the webs to the films of the resealable package at room temperature.

4. The zipper assembly of claim 1, wherein the webs, the interlocking bodies, the PSA layers, and the release liners are formed from materials configured to be co-extruded to form the webs, the interlocking bodies, the PSA layers, and the release liners at a common time.

5. The zipper assembly of claim 1, wherein the release liners include silicone.

6. The zipper assembly of claim 1, wherein the zipper assembly is a single segment zipper assembly configured to mate to itself.

7. The zipper assembly of claim 1, wherein the zipper assembly is a multi-segment zipper assembly having different segments configured to mate to each other.

8. A method comprising:
co-extruding opposing webs, interlocking bodies that protrude from the webs, pressure sensitive adhesive (PSA) layers on the webs, and release liners on the PSA layers, wherein the webs, the interlocking bodies, the PSA layers, and the release liners are co-extruded to form a zipper assembly for a resealable package.

9. The method of claim 8, wherein the webs, the interlocking bodies, the PSA layers, and the release liners are co-extruded with each of the webs having an interlocking side and an opposite film side, and with the interlocking bodies configured to mate with each other.

10. The method of claim 9, wherein the webs, the interlocking bodies, the PSA layers, and the release liners are co-extruded with the PSA layers disposed on the film sides of the webs and the PSA layers including PSA configured to couple the webs to inside surfaces of films of the resealable package.

11. The method of claim 10, wherein the webs, the interlocking bodies, the PSA layers, and the release liners are co-extruded with the release liners disposed on the PSA layers, the release liners configured to be separated from the PSA layers prior to pressing the webs and the PSA layers into contact with the films of the resealable package to adhere the webs to the films.

12. A zipper assembly for a resealable package, the zipper assembly comprising:
opposing webs each having an interlocking side and an opposite film side, each of the interlocking sides having a protruding interlocking body configured to mate with the protruding interlocking body of the other interlocking side to mate the webs with each other; and
pressure sensitive adhesive (PSA) layers disposed on the film sides of the webs, the PSA layers including PSA configured to couple the webs to inside surfaces of films of the resealable package.

13. The zipper assembly of claim 12, further comprising:
release liners disposed on the PSA layers and configured to be separated from the PSA layers prior to pressing the webs and the PSA layers into contact with the films of the resealable package to adhere the webs to the films.

14. The zipper assembly of claim 13, wherein the release liners include silicone.

15. The zipper assembly of claim 13, wherein the PSA layers and the release liners are formed from incompatible polymer materials.

16. The zipper assembly of claim 13, wherein the release liners are each formed from multiple layers.

17. The zipper assembly of claim 12, wherein the PSA layers are configured to affix the webs to the films of the resealable package without heating the PSA layers or the films.

18. The zipper assembly of claim 12, wherein the PSA layers are configured to couple the webs to the films of the resealable package at room temperature.

19. The zipper assembly of claim 12, wherein the PSA layers are configured to couple the webs to the films of the resealable package at a temperature between twenty and twenty-nine degrees Celsius.

20. The zipper assembly of claim 12, wherein the PSA layers and the webs are formed from compatible polymer materials.
